(19) United States
(12) Patent Application Publication
(10) Pub. No.: US 2016/0163331 A1
(43) Pub. Date: Jun. 9, 2016

(54) ELECTRONIC DEVICE AND METHOD FOR VISUALIZING AUDIO DATA

(71) Applicant: Kabushiki Kaisha Toshiba, Tokyo (JP)

(72) Inventor: Ryuichi Yamaguchi, Ome Tokyo (JP)

(21) Appl. No.: 14/709,229

(22) Filed: May 11, 2015

Related U.S. Application Data
(60) Provisional application No. 62/087,467, filed on Dec. 4, 2014.

(51) Int. Cl. G10L 21/12

(52) U.S. Cl. CPC G10L 21/12

(57) ABSTRACT

According to one embodiment, an electronic displays a first block including speech segments, wherein a main speaker of the first block is visually distinguishable. When the first block includes a first speech segment of a first speaker and a second speech segment of a second speaker, the first speech segment is longer than the second speech segment, and the second speaker is not a speaker whose amount of speech of the sequence of the audio data is smaller than that of the first speaker or a first amount, the first speaker is determined as a main speaker of the first block.

### CROSS-REFERENCE TO RELATED APPLICATIONS

This application claims the benefit of U.S. Provisional Application No. 62/087,467, filed Dec. 4, 2014, the entire contents of which are incorporated herein by reference.

### FIELD

Embodiments described herein relate generally to a technique of processing audio data.

### BACKGROUND

In recent years, various electronic devices such as personal computers (PC), tablets, and smartphone have been developed. Many of these devices can handle a variety of audio sources such as music, speech, and various other sounds.

However, no consideration has been given for a technique of presenting to the user an outline of recorded data such as a recording of a meeting.

It is therefore demanded that a new visualization technique capable of overviewing the content of recorded data be realized.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view illustrating an exterior of an electronic device of an embodiment.

FIG. 2 is an exemplary block diagram illustrating a system configuration of the electronic device.

FIG. 3 is an exemplary diagram illustrating a functional configuration of a sound recorder application program executed by the electronic device.

FIG. 4 is an exemplary view illustrating a home view displayed by the sound recorder application program.

FIG. 5 is an exemplary view illustrating a recording view displayed by the sound recorder application program.

FIG. 6 is an exemplary view illustrating a play view displayed by the sound recorder application program.

FIG. 7 is an exemplary view illustrating selected speaker playback processing executed by the sound recorder application program.

FIG. 8 is an exemplary view illustrating processing for determining a main speaker for each block.

FIG. 9 is another exemplary view illustrating processing for determining a main speaker for each block.

FIG. 10 is an exemplary view illustrating speaker identification result information obtained by speaker clustering.

FIG. 11 is an exemplary view illustrating main speaker management information generated based on speaker identification result information.

FIG. 12 is an exemplary view illustrating a display content of a speaker identification result area.

FIG. 13 is an exemplary view illustrating another display content of a speaker identification result area.

FIG. 14 is a flowchart illustrating steps of processing for displaying a speaker identification result area corresponding to audio data to be played back.

FIG. 15 is a flowchart illustrating steps of selected speaker playback processing.

FIG. 16 is an exemplary view illustrating a user interface for speaker selection.

### DETAILED DESCRIPTION

Various embodiments will be described hereinafter with reference to the accompanying drawings.

In general, according to one embodiment, an electronic device comprises circuitry. The circuitry is configured to execute a first process for displaying a first block comprising speech segments, wherein a main speaker of the first block is visually distinguishable. The first block is one of a plurality of blocks included in a sequence of audio data. When the first block comprises a first speech segment of a first speaker and a second speech segment of a second speaker, the first speech segment is longer than the second speech segment, and the second speaker is not a speaker whose amount of speech in the sequence of the audio data is smaller than that of the first speaker or a first amount, the first speaker is determined as a main speaker of the first block. When the first block comprises the first speech segment and the second speech segment, the first speech segment is longer than the second speech segment, and the second speaker is a speaker whose amount of speech in the sequence of the audio data is smaller than that of the first speaker or the first amount, the second speaker is determined as the main speaker of the first block.

The electronic device of the embodiment can be realized as, for example, a tablet computer, a smartphone, a personal digital assistant (PDA), or the like. It is assumed in the following that the electronic device is realized as a tablet computer 1.

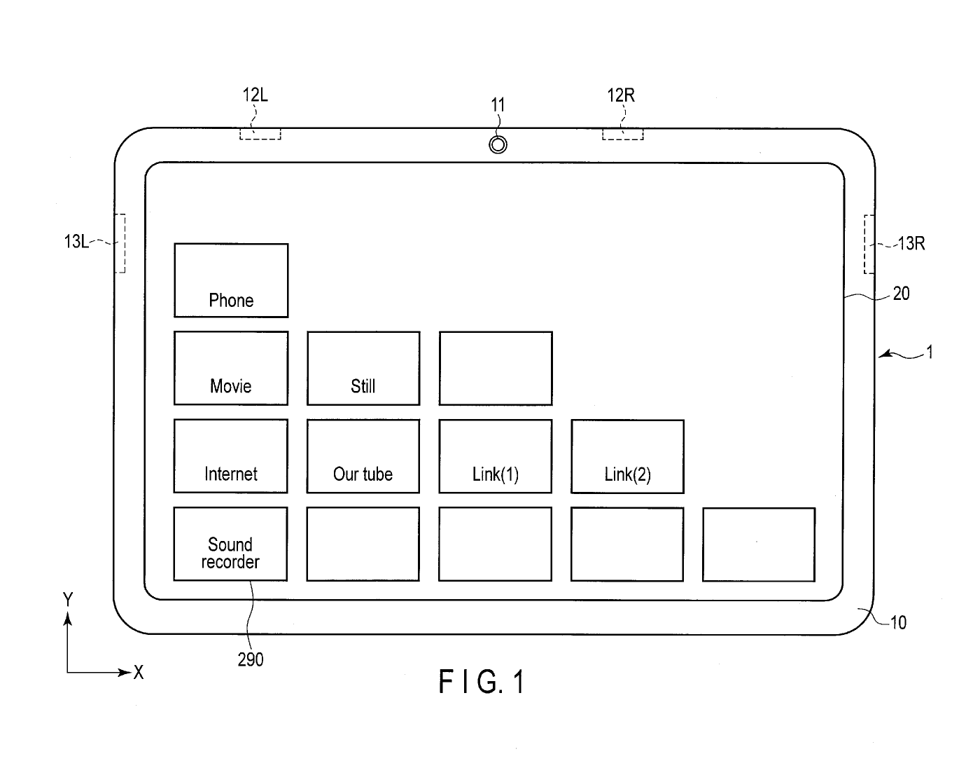

FIG. 1 is a view illustrating the exterior of the tablet computer 1. As shown in FIG. 1, the tablet computer 1 includes a main body 10 and a touchscreen display 20.

A camera (camera unit) 11 is provided in a predetermined location of the main body 10, for example, in the middle of the upper end of the surface of the main body 10. Further, microphones 12R and 12L are provided in two predetermined locations of the main body 10, for example, in two locations separated with each other on the upper end of the surface of the main body 10. The camera 11 may be located between the two microphones 12R and 12L. Also, the number of microphones provided may be one.

Also, loudspeakers 13R and 13L are provided in two predetermined locations of the main body 10, for example, in the left and right side surfaces of the main body 10.

The touchscreen display 20 includes a liquid crystal display unit (LCD/display unit) and a touchpanel. The touchpanel is attached to the surface of the main body 10 so as to cover the screen of the LCD.

The touchscreen display 20 detects a contact location between an external object (stylus or finger) and the screen of the touchscreen display 20. The touchscreen display 20 may support a multi-touch function capable of detecting a plurality of contact locations simultaneously.

The touchscreen display 20 can display on the screen some icons for launching each type of application programs. These icons may include an icon 290 for launching a sound recorder application program. The sound recorder application program has a function to visualize the content of a recording of, for example, a meeting.

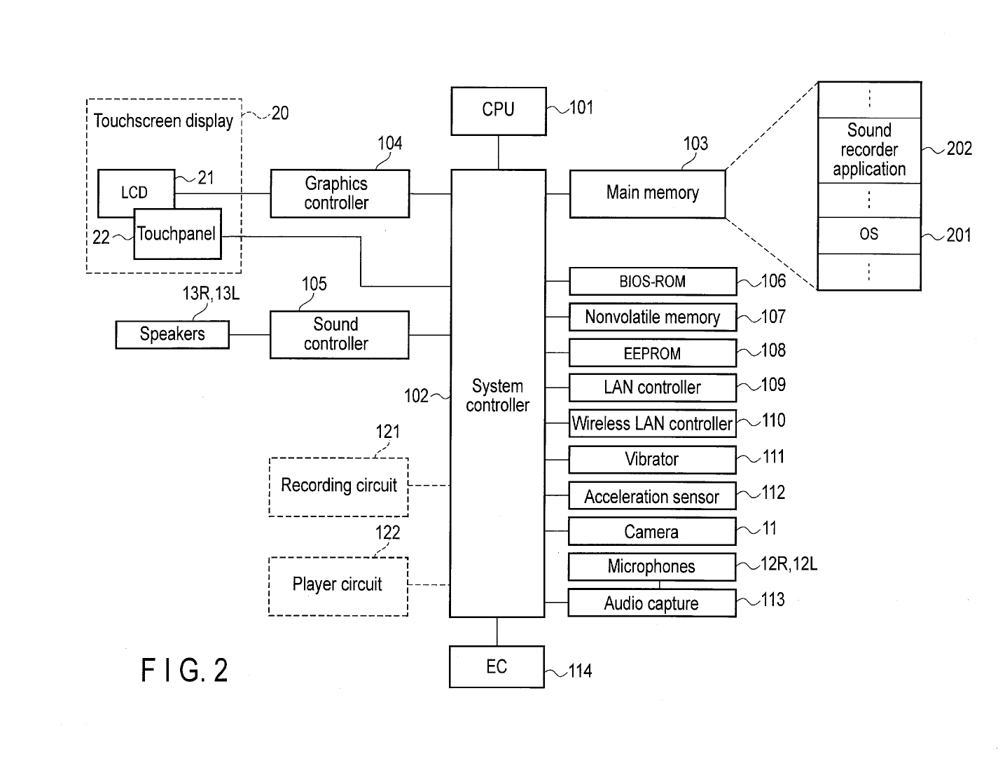

FIG. 2 illustrates the system configuration of the tablet computer 1.

As shown in FIG. 2, the tablet computer 1 includes, a CPU 101, a system controller 102, a main memory 103, a graphics controller 104, a sound controller 105, a BIOS-ROM 106, a nonvolatile memory 107, an EEPROM 108, a LAN controller 109, a wireless LAN controller 110, a vibrator 111, an acceleration sensor 112, an audio capture 113, an embedded controller (EC) 114, etc.

The CPU 101 is a processor configured to control the operation of components in the tablet computer 1. This processor includes circuitry (processing circuitry). The CPU 101 executes each type of programs that are loaded from the nonvolatile memory 107 to the main memory 103. These programs include an operating system (OS) 201 and various application programs. These application programs include a sound recorder application program 202.

Features of the sound recorder application program 202 will be described.

The sound recorder application program 202 can record audio data corresponding to sound that is input via the microphones 12R and 12L.

The sound recorder application program 202 supports a speaker clustering function. The speaker clustering function can classify the respective speech segments in a sequence of audio data into a plurality of clusters corresponding to a plurality of speakers in the audio data.

The sound recorder application program 202 has a visualization function to display the respective speech segments per speaker by using a result of speaker clustering. With this visualization function, it is possible to clearly present to the user when and by which speaker speech is made.

The sound recorder application program 202 supports a speaker selection playback function to continuously play back only the speech periods of selected speakers.

Each of these functions of the sound recorder application program 202 can be realized by circuitry such as a processor. In addition, these functions can also be realized by a dedicated circuit such as a recording circuit 121 or a player circuit 122.

The CPU 101 also executes a Basic Input/Output System (BIOS) stored in the BIOS-ROM 106. The BIOS is a program for hardware control.

The system controller 102 is a device that connects the local bus of the CPU 101 and each type of components. The system controller 102 is equipped with a memory controller for performing access control for the main memory 103. The system controller 102 also has a function to execute communication with the graphics controller 104 via, for example, a serial bus conforming to the PCI EXPRESS standard.

Moreover, the system controller 102 is equipped with an ATA controller for controlling the nonvolatile memory 107. The system controller 102 is also equipped with a USB controller for controlling each type of USB devices. Further, the system controller 102 has a function to execute communication with the sound controller 105 and the audio capture 113.

The graphics controller 104 is a display controller for controlling an LCD 21 of the touchscreen display 20. The display controller includes a circuit (display control circuit). A display signal generated by the graphics controller 104 is transmitted to the LCD 21. The LCD 21 displays a screen image based on the display signal. The touchpanel 22 which covers the LCD 21 functions as a sensor configured to detect a contact position between the screen of the LCD 21 and an external object. The sound controller 105 is a sound source device. The sound controller 105 converts audio data to be played back into analogue signals and then outputs them to the loudspeakers 13R and 13L.

The LAN controller 109 is a wired communication device configured to execute wired communication conforming to, for example, the IEEE 802.3 standard. The LAN controller 109 includes a transmission circuit configured to transmit a signal and a reception circuit configured to receive a signal. The wireless LAN controller 110 is a wireless communication device configured to execute wireless communication conforming to, for example, the IEEE 802.11 standard. The wireless LAN controller 110 includes a transmission circuit configured to wirelessly transmit a signal and a reception circuit configured to wirelessly receive a signal.

The vibrator 111 is a device that generates vibration. The acceleration sensor 112 is used to detect a current orientation (portrait orientation/landscape orientation) of the main body 10.

The audio capture 113 converts sound that is input via the microphones 12R and 12L from analogue into digital and outputs a digital signal corresponding to this sound. The audio capture 113 can transmit to the sound recorder application program 202 information indicating which microphone 12R or 12L produces a larger sound level.

The EC 114 is a single-chip microcomputer including an embedded controller for power management. The EC 114 powers on or off the tablet computer 1 in accordance with the user's operation of the power button.

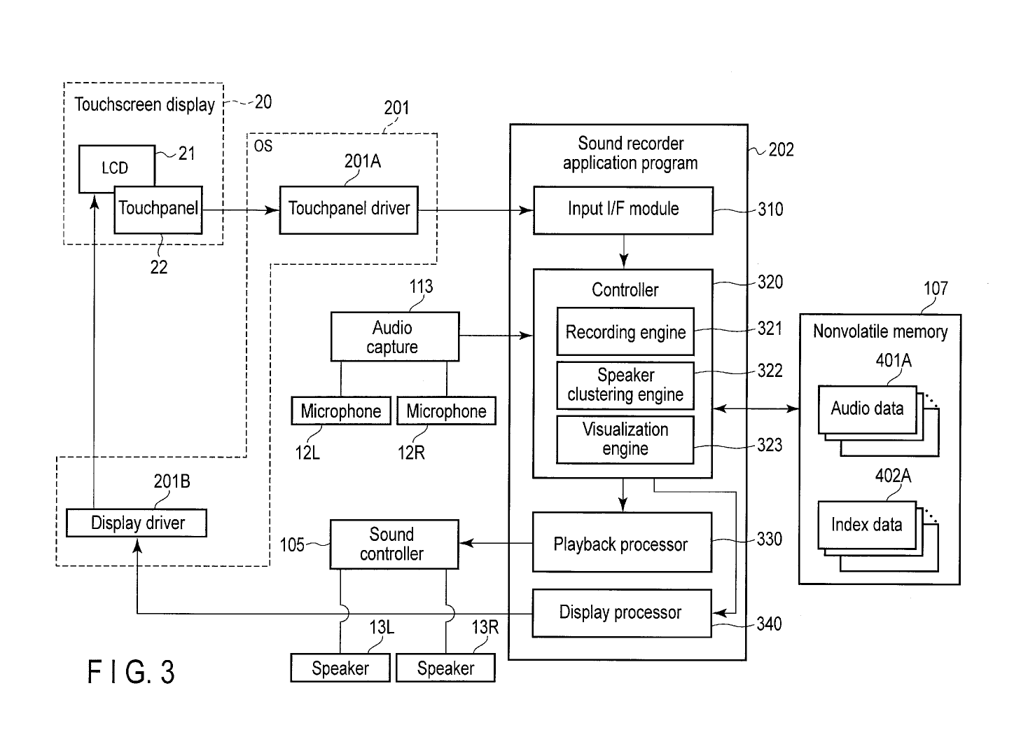

FIG. 3 illustrates the functional configuration of the sound recorder application program 202.

The sound recorder application program 202 includes, as the functional modules of the program, an input interface (I/F) module 310, a controller 320, a playback processor 330 and a display processor 340.

The input interface (I/F) module 310 receives various events from the touchpanel 22 via a touchpanel driver 201A. These events include a touch event, a movement event and a release event. A touch event is an event indicating that an external object contacts the screen of the LCD 21. This touch event includes a coordinate that shows a contact location between the screen and the external object. A movement event is an event indicating that a contact location is moved with an external object contacting the screen. This movement event includes a coordinate of the contact location of the movement destination. A release event is an event indicating that a contact between an external object and the screen is released. This release event includes a coordinate that shows a contact location where the contact is released.

The controller 320 can detect which finger gesture (tap, swipe, flick, pinch, etc.) is performed on which location of the screen, based on various events received from the input interface (I/F) module 310. The controller 320 includes a recording engine 321, a speaker clustering engine 322, a visualization engine 323, etc.

The recording engine 321 records in the nonvolatile memory 107 audio data 401A which corresponds to sound input via the microphones 12L and 12R and the audio capture 113. The recording engine 321 can record various scenes such as meeting, telephone conversation and presentation. The recording engine 321 can also record other types of audio sources such as broadcast and music.

The speaker clustering engine 322 executes speaker identification processing by analyzing the audio data 401A (recorded data). In speaker identification processing, it is detected when and by which speaker speech is made. Speaker identification processing is executed for each sound data sample having a duration of, for example, 0.5 seconds. That is, a sequence of audio data (recorded data), i.e., a signal sequence of a digital audio signal, is transmitted to the speaker clustering engine 322 for each sound data unit having a duration of 0.5 seconds (a collection of sound data samples of 0.5 seconds). The speaker clustering engine 322 executes speaker identification processing for each sound data unit. Thus, a sound data unit of 0.5 seconds is an identification unit for identifying a speaker.

Speaker identification processing may include speech detection and speaker clustering, although not limited thereto. In speech detection, it is detected whether each sound data unit is a speech (human voice) segment or a non-speech segment (noise segment or silent segment) other than a speech segment. The processing of this speech detection may be realized with, for example, voice activity detection (VAD). The processing of this speech detection may also be executed in real time during sound recording.

In speaker clustering, it is identified which speaker's speech included in a sequence from the beginning point to the end point of audio data corresponds to each speech segment included in the sequence. That is, in speaker clustering, each speech segment is classified into a plurality of clusters corresponding to a plurality of speakers in the audio data. Each cluster is a collection of sound data units of the same speaker.

Various existing methods can be used as methods for executing speaker clustering. In the embodiment, a method for executing speaker clustering using a speaker location and a method for executing speaker clustering using a feature amount of speech (acoustic feature amount) may be both used, although not limited thereto.

A speaker location represents the location of an individual speaker for the tablet computer 1. The speaker location can be estimated based on the difference between the two sound signals input via the two microphones 12L and 12R. Each speech input from the same speaker location is each estimated as the speech of the same speaker.

In the method for executing speaker clustering using a feature amount of speech, sound data units having feature amounts that are mutually similar are classified into the same cluster (same speaker). The speaker clustering engine 322 extracts, from each sound data unit determined as speech, a feature amount such as a mel frequency cepstral coefficient (MFCC). The speaker clustering engine 322 can execute speaker clustering in view of the feature amount of each sound data unit as well as the speaker location of each sound data unit.

A method disclosed in, for example, Jpn. Pat. Appln. KOKAI Publication No. 2011-191824 (Japanese Patent No. 5174068) may be used as the method of speaker clustering using a feature amount.

Information showing a result of speaker clustering is saved as index data 402A in the nonvolatile memory 107.

In collaboration with the display processor 340, the visualization engine 323 executes processing for visualizing the outline of the entire sequence of the audio data 401A. In more detail, the visualization engine 323 displays a display area that shows an entire sequence. The visualization engine 323 displays, on this display area, individual speech segments in a form where speakers of the individual speech segments can be identified.

The visualization engine 323 can visualize each speech segment by using the index data 402A. However, the length of each speech segment may vary to a great extent for each speaker in the recording of a meeting, etc. That is, short speech segments and relatively long speech segments may be mixed in the audio data 401A.

Therefore, if a method for faithfully reproducing the location and length of an individual speech segment is used, there is a possibility that an extremely short bar that is hard to view is drawn on a display area. In the recording of a heated meeting where speakers are frequently switched within a short time, there is also a possibility that a large number of extremely short bars that are hard to view are displayed in an overcrowding state in the recording of a heated meeting where speakers are frequently switched within a short time.

The size of a display area is limited. Thus, in a long recording of, for example, approximately three hours, the area of a section in the display area allocated to each identification unit is extremely narrow. Therefore, if the location and size of an individual speech segment are faithfully drawn on the display area for each identification unit, it is likely that each of the short speech segments is displayed like a small point or is displayed in a state of being hardly viewed.

Accordingly, the visualization engine 323 divides a sequence of the audio data 401A into a plurality of blocks (a plurality of periods). The visualization engine 323 then displays each block including a plurality of speech segments in a form where the speaker of each block (main speaker) can be visually distinguished, in color allocated to the main speaker, for example. The visualization engine 323 can thereby present to the user a block including some short speeches, as if the entire block is an actual speech segment of the main speaker of this block. It is therefore possible to clearly present to the user when and by which speaker speech is mainly made, even in a long recording of approximately three hours.

For example, it is assumed in a certain block that the speech segments of a plurality of speakers are included. In this case, any of these speakers is determined as a main speaker of this block. For example, a speaker whose amount of speech is the largest in this block may be determined as a main speaker of this block.

For example, it is assumed that a first speech segment of a first speaker and a second speech segment of a second speaker belong to a first block.

In this case, if the first speech segment is longer than the second speech segment, the visualization engine 323 may determine that the first speaker is a main speaker of the first block.

The first block is thereby displayed in, for example, color allocated to the first speaker, which is a main speaker of the first block. The first block may also be displayed in a line type (solid line, broken line, bold line, etc.) allocated to the first speaker or be displayed in transparency (thick, thin, middle, etc.) allocated to the first speaker.

If some speech segments of the first speaker exist in the first block, the total duration of these speech segments may be used as the length (duration) of the above-mentioned first speech segment. Similarly, if some speech segments of the second speaker exist in the first block, the total duration of these speech segments may be used as the length (duration) of the above-mentioned second speech segment. It is thereby possible to determine a speaker whose amount of speech is the largest in the first block as a main speaker of the first block.

Alternatively, if some speech segments of the first speaker exist in the first block, the longest speech segment of these speech segments may be used as the length (duration) of the above-mentioned first speech segment. Similarly, if some speech segments of the second speaker exist in the first block, the longest speech segment of these speech segments may be used as the length (duration) of the above-mentioned second speech segment.

The visualization engine 323 is configured to determine a main speaker of each block in view of the relationship of the amount of speech between speakers of the entire sequence of audio data as well as the relationship of the amount of speech between speakers in each block.

It is assumed that the first speech segment of the first speaker and the second speech segment of the second speaker belong to the first block and that the first speech segment is longer than the second speech segment. In this case, the visualization engine 323 determines whether the second speaker is smaller than the first speaker in the amount of speech of a sequence of audio data. In this case, for example, the visualization engine 323 may determine whether the second speaker is a speaker (speaker X) whose amount of speech is the smallest in a sequence of audio data.

If the second speaker is not a speaker whose amount of speech in a sequence of audio data is smaller than that of the first speaker (i.e., the amount of speech of the second speaker of the entire sequence of audio data is not smaller than that of the first speaker), the first speaker is determined as a main speaker of the first block. For example, if the second speaker is not a speaker (speaker X) whose amount of speech is the smallest in a sequence of audio data, the first speaker is determined as a main speaker of the first block.

In contrast, if the second speaker is a speaker whose amount of speech in a sequence of audio data is smaller than that of the first speaker (i.e., the amount of speech of the second speaker of the entire sequence of audio data is smaller than that of the first speaker), the second speaker is determined as a main speaker of the first block. For example, if the second speaker is a speaker (speaker X) whose amount of speech is the smallest in a sequence of audio data, the second speaker is determined as a main speaker of the first block.

Thus, in the embodiment, regarding a block where a speech segment of a speaker exists whose amount of speech is small in a sequence of audio data (for example, a speaker [speaker X] whose amount of speech is the smallest), this speaker is determined as a main speaker of this block even if the amount of speech in this block of this speaker is smaller than that of other speakers. For example, in audio data where five speakers exist, regarding a block where a speech segment of a speaker whose amount of speech is ranked fifth exists, the speaker whose amount of speech is ranked fifth may be determined as a main speaker in priority.

It may be possible to use a condition where the second speaker is a speaker whose amount of speech of a sequence of audio data is smaller than a first amount (standard value) (i.e., the amount of speech of the second speaker in the entire sequence of audio data is smaller than the first amount [standard value]), instead of a condition where the second speaker is a speaker whose amount of speech of a sequence of audio data is the smallest. The first amount (standard value) may be a value determined according to the duration of audio data. For example, the first amount (standard value) may be five minutes in audio data of three hours; the first amount (standard value) may be three minutes in audio data of two hours. If the second speaker is a speaker whose amount of speech in a sequence of audio data is smaller than the first amount (standard value), the second speaker may be determined as a main speaker of the first block.

The playback processor 330 plays back the audio data 401A. The playback processor 330 can continuously play back only speech segments while skipping silent segments. Further, the playback processor 330 can execute selected speaker play processing where only the speech segments of a particular speaker selected by the user are continuously played back while skipping speech segments of other speakers.

Next, views (home view, recording view and play view) displayed on the screen by the sound recorder application program 202 will be described.

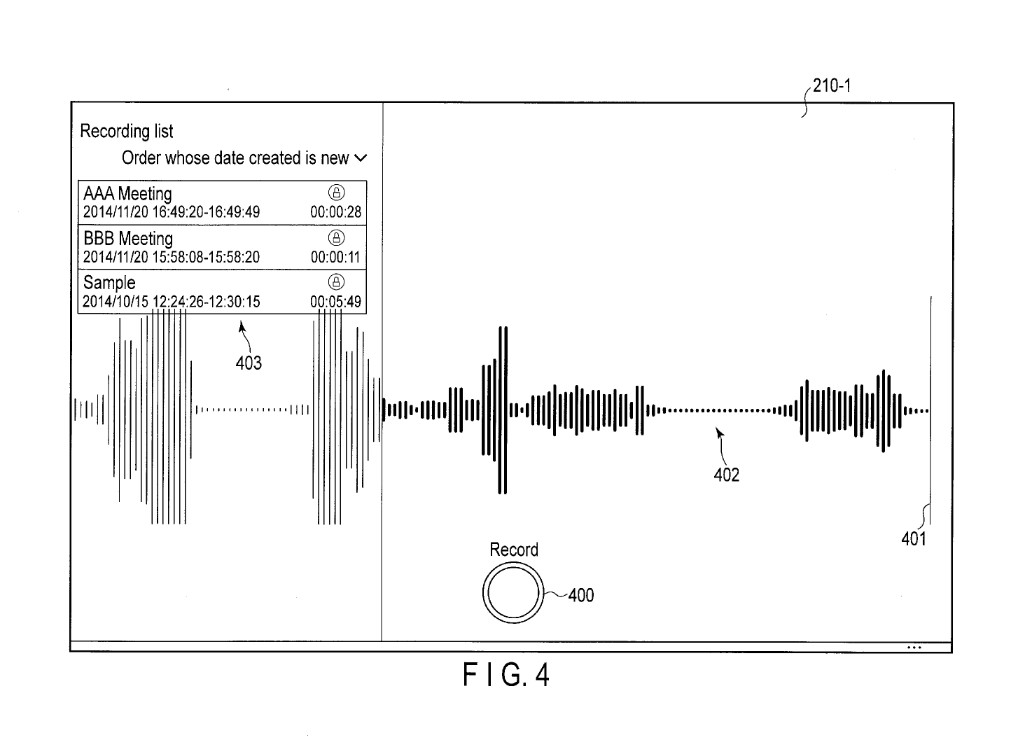

FIG. 4 illustrates a home view 210-1.

The sound recorder application program 202, when launched, displays the home view 210-1.

As shown in FIG. 4, the home view 210-1 displays a record button 400, a sound waveform 402 and a recording list 403. The record button 400 is a button for instructing to start recording.

The sound waveform 402 shows the waveforms of sound signals being input via the microphones 12L and 12R. The waveforms of sound signals successively appear from a vertical bar 401. As time elapses, the waveforms of sound signals move from the vertical bar 401 toward the left. In the sound waveform 402, the waveforms of a sound signals are displayed by continuous vertical bars. The continuous vertical bars each have a length depending on each power of the continuous sound signal samples. The display of the sound waveform 402 enables the user to confirm whether sounds are normally input before starting recording.

The recording list 403 displays a list of recordings. Each recording is stored in the nonvolatile memory 107 as the audio data 401A. It is assumed that three recordings exist, i.e., a recording entitled “AAA Meeting,” a recording entitled “BBB Meeting” and a recording entitled “Sample.”

The recording list 403 displays the recording date, recording time and recording end time of each recording. In the recording list 403, it is possible to sort out recordings in an order whose date created is new or old.

When a recording in the recording list 403 is selected with the user's tap operation, the sound recorder application program 202 starts playing back the recording selected.

When the record button 400 of the home view 210-1 is tapped by the user, the sound recorder application program 202 starts recording.

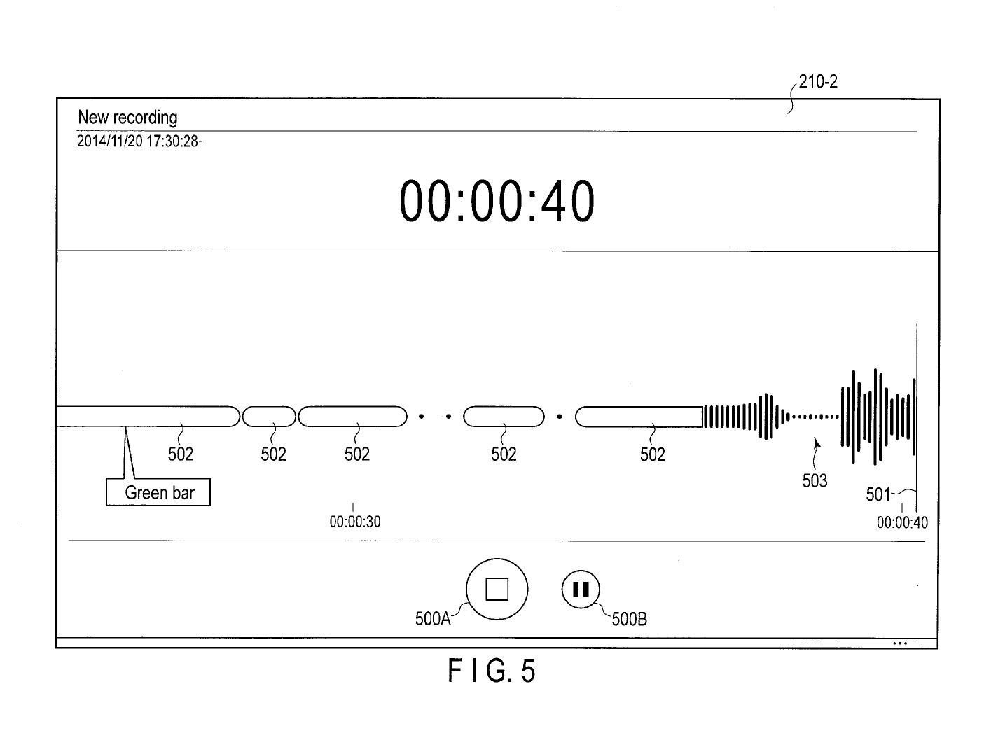

FIG. 5 illustrates a recording view 210-2.

When the record button 400 is tapped by the user, the sound recorder application program 202 starts recording and switches its display screen from the home view 210-1 of FIG. 4 to the recording view 210-2 of FIG. 5.

The recording view 210-2 displays a stop button 500A, a pause button 500B, speech segment bars (green) 502 and a sound waveform 503. The stop button 500A is a button for stopping current recording. The pause button 500B is a button for pausing current recording.

The sound waveform 503 shows the waveforms of sound signals being input via the microphones 12L and 12R. The waveforms of sound signals successively appear from a vertical bar 501 and moves leftward as time elapses. In the sound waveform 503, the waveforms of sound signals are displayed by a large number of vertical bars each having a length according to the power of the sound signal.

During recording, the above-mentioned speech detection is performed. When it is detected that one or more sound data units in a sound signal are speech (human voice), speech segments corresponding to the one or more sound data units are visualized by the speech segment bars (for example, green) 502. The length of each speech segment bar 502 varies depending on the duration of its corresponding speech segment.

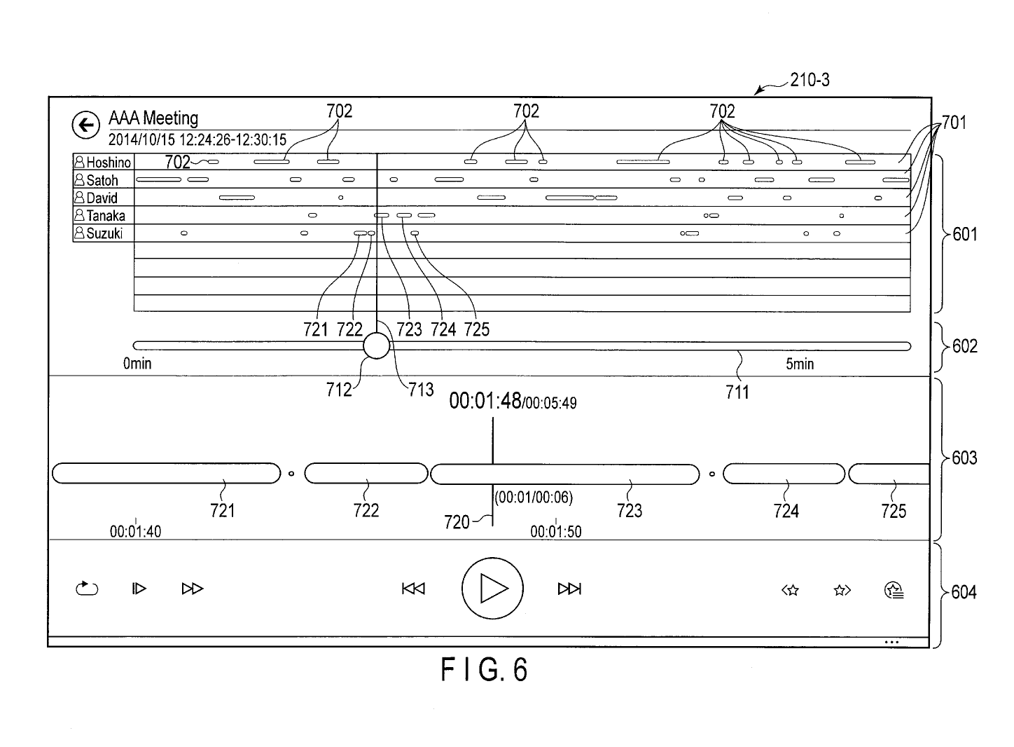

FIG. 6 illustrates a play view 210-3.

The play view 210-3 of FIG. 6 indicates a state where playback of the recording entitled “AAA Meeting” is paused during the playback. As shown in FIG. 6, the play view 210-3 displays a speaker identification result view area 601, a seek bar area 602, a play view area 603 and a control panel 604.

The speaker identification result view area 601 is a display area that displays the entire sequence of the recording entitled “AAA Meeting.” The speaker identification result view area 601 may display a plurality of time bars (also called time lines) 701 which correspond to a plurality of speakers in the sequence of this recording. In this case, when five speakers are included in the sequence of this recording, five time bars 701 which correspond to the five speakers are displayed. The sound recorder application program 202 can identify up to ten speakers per recording and display up to ten time bars 701.

In the speaker identification result view area 601, the five speakers are sequentially arranged in an order whose amount of speech is larger in the entire sequence of the recording entitled “AAA Meeting.” A speaker whose amount of speech is the largest in the entire sequence is displayed at the top of the speaker identification result view area 601.

Each time bar 701 is a display area elongated in a time axis direction (lateral direction). The left end of each time bar 701 corresponds to the start time of the sequence of this recording and the right end of each time bar 701 corresponds to the end time of the sequence of this recording. That is, the total time from start to end of the sequence of this recording is allocated to each time bar 701.

FIG. 6 shows the names of speakers (“Hoshino,” “Satoh,” “David,” “Tanaka” and “Suzuki”) next to human icons. These names of speakers are information added with the user's edit operation. These names of speakers are not displayed in the initial state where the user's edit operation has not been performed yet. In addition, in the initial state, signs such as “A,” “B,” “C,” “D,” . . . instead of names of speakers may be displayed next to human icons.

The time bar 701 of a certain speaker displays a speech segment bar that indicates the location and duration of each speech segment of the speaker. Different colors may be allocated to a plurality of speakers. In this case, speech segment bars in different colors may be displayed for each speaker. For example, in the time bar 701 of the speaker “Hoshino,” a speech segment bar 702 may be displayed in color allocated to the speaker “Hoshino” (for example, red).

Each time bar 701 includes the above-mentioned plurality of blocks. In other words, the sequence of the recording entitled “AAA Meeting” is divided into a plurality of blocks (for example, 960 blocks) and these blocks are allocated to the respective time bars 701.

As described above, a main speaker is determined for each block that includes one or more speech segments. For example, in the time bar 701 of the speaker “Hoshino,” a block where the speaker “Hoshino” is determined as a main speaker is displayed in color (red) allocated to the speaker “Hoshino.” That is, each speech segment bar 702 indicates not an actual speech segment detected but one or more continuous blocks where the speaker “Hoshino” is determined as a main speaker.

That is, each speech segment bar 702 is constituted by one red block or by some continuous red blocks.

Thus, each time bar 701 displays as a speech segment bar a speech segment adjusted (extended) to an easily viewable length, not an actual speech segment detected.

The seek bar area 602 displays a seek bar 711 and a moveable slider (also called locator) 712. The total time from start to end of the sequence of this recording is allocated to the seek bar 711. The location of the slider 712 on the seek bar 711 displays a current playback location. A vertical bar 713 extends upward from the slider 712. The vertical bar 713 traverses the speaker identification result view area 601, which enables the user to easily understand which speech segment of a speaker (main speaker) the current playback location is.

The location of the slider 712 on the seek bar 711 moves rightward as playback progresses. The user can move the slider 712 rightward or leftward with a drag operation. This enables the user to change the current playback location to an arbitrary location.

Further, by tapping an arbitrary location on the time bar 701 corresponding to an arbitrary speaker, the user can change the current playback location to a location corresponding to the tapped location. For example, when a certain location on one of the time bars 701 is tapped, the current playback location is changed to the certain location.

Also, by sequentially tapping the speech segments (speech segment bars) of a particular speaker, the user can listen to each speech segment of this particular speaker.

The play view area 603 is an enlarged view of a period adjacent to a current playback location (for example, a period of approximately 20 seconds). The play view area 603 includes a display area elongated in a time axis direction (lateral direction). The play view area 603 chronologically displays some speech segments (actual speech segments detected) included in a period adjacent to the current playback location. A vertical bar 720 indicates a current playback location.

The vertical bar 720 is displayed in the middle of the left and right ends of the play view area 603. The location of the vertical bar 720 is fixed. As playback progresses, a display content of the play view area 603 is scrolled from right to left. That is, as playback progresses, some speech segment bars on the play view area 603, i.e., speech segment bars 721, 722, 723, 724 and 725 are moved from right to left.

In the play view area 603, the length of each speech segment bar is not an adjusted length but an actual length of a detected speech segment. A period allocated to the play view area 603 is a partial period (for example, 20 seconds) of the sequence of a recording. Therefore, a speech segment bar does not become extremely short, even if the play view area 603 displays a speech segment bar having an actual length of a detected speech segment.

When the user flicks the play view area 603, a display content of the play view area 603 is scrolled to the left or right with the location of the vertical bar 720 fixed. This also changes the current playback location.

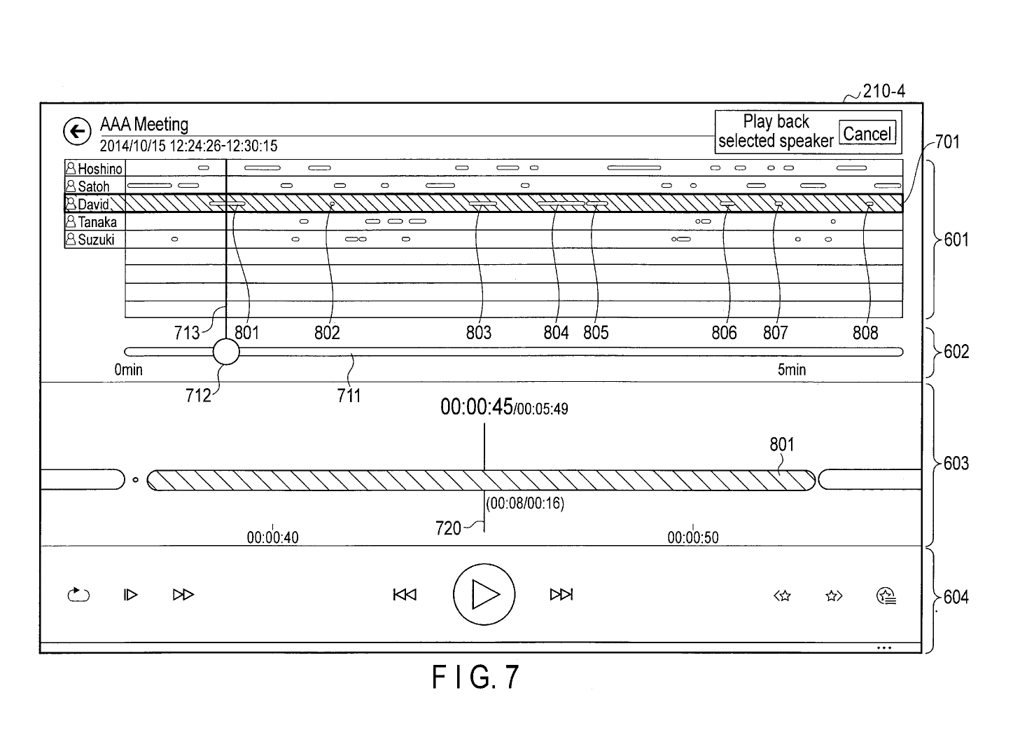

Next, a selected speaker play view 210-4 displayed on the screen by the sound recorder application program 202 will be described with reference to FIG. 7.

The selected speaker play view 210-4 is displayed during execution of selected speaker playback processing. The selected speaker play view 210-4 displays the above-mentioned speaker identification result view area 601, seek bar area 602, play view area 603 and control panel 604.

In the speaker identification result view area 601, the sound recorder application program 202 highlights the time bar 701 of a speaker selected by the user. In this highlight, the background color of the time bar 701 and the color of each speech segment bar may be inverted. The sound recorder application program 202 may display the time bars 701 of the other speakers inconspicuously (for example, gray).

For example, when the speaker “David” is selected, the sound recorder application program 202 highlights the time bar 701 of the speaker “David.” The sound recorder application program 202 then continuously plays back only the speech segments (for example, actual speech periods detected) of the speaker “David” while skipping speech segments of other speakers. For example, when a speech segment of the speaker “David” corresponding to a speech segment bar 801 has been played back, the sound recorder application program 202 automatically changes the current playback location to the speech segment of the speaker “David” corresponding to a speech segment bar 802. When a speech segment of the speaker “David” corresponding to the speech segment bar 802 has been played back, the sound recorder application program 202 automatically changes the current playback location to a speech segment of the speaker “David” corresponding to a speech segment bar 803.

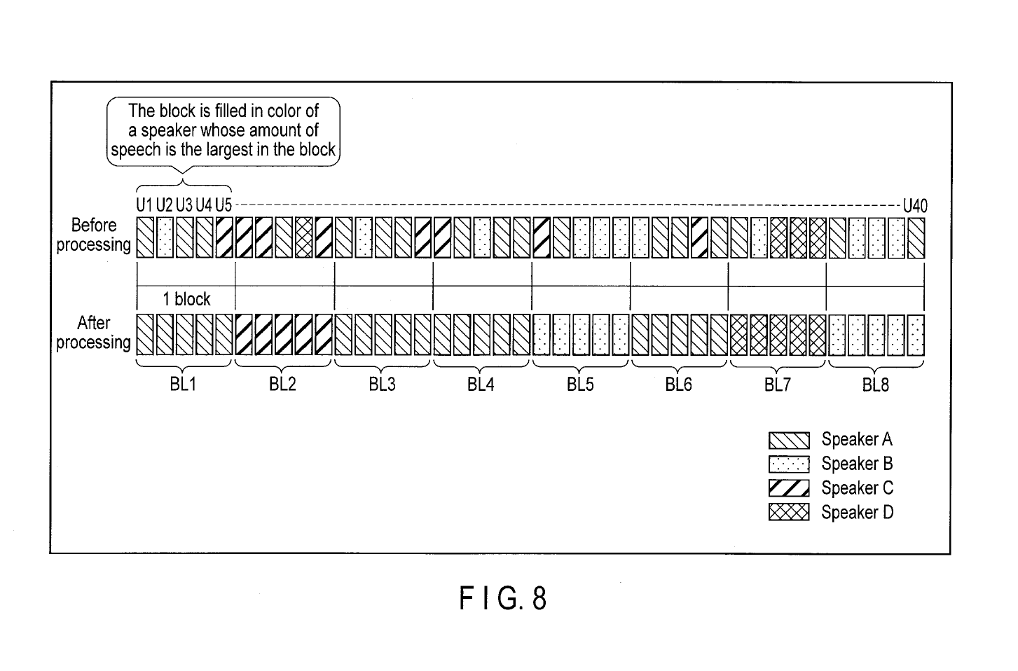

Next, the processing for determining a main speaker for each block will be described with reference to FIG. 8.

The upper section of FIG. 8 illustrates a result of the above-mentioned speaker identification processing (speaker clustering). As described above, speaker identification processing is executed in a sound data unit (identification unit) of 0.5 seconds. In FIG. 8, for example, sound data units U1, U3 and U4 are each identified as speech of speaker A, sound data unit U2 is identified as speech of speaker B, and sound data unit U5 is identified as speech of speaker C.

As described above, the entire sequence of a recording to be played back is allocated to the time bar 701 of the speaker identification result view area 601. When the total duration of audio data is, for example, three hours, the number of sound data units included in the sequence of this audio data is 21,500. Therefore, if a result of speaker identification processing is faithfully reproduced on the time bar 701, the time bar 701 is divided into 21,500 sections. Accordingly, the area of one section in the time bar 701 allocated to one sound data unit is extremely narrow.

In view of such a problem, the sound recorder application program 202 divides the sequence of a recording (audio data) to be played back into a plurality of blocks (for example, 960 blocks), as shown in the lower section of FIG. 8. The duration of one block depends on the total duration of audio data. For example, the duration of one block is 22.5 seconds in audio data of three hours. One block includes 45 sound data units. The sound recorder application program 202 determines the respective main speakers of 960 blocks based on the result of speaker identification processing (speaker clustering).

In FIG. 8, it is assumed for simple illustration that the sequence of audio data is constituted by eight blocks and one block is constituted by five continuous sound data units.

Sound data units U1 to U5 belong to block BL1. As described above, each of sound data units U1, U3 and U4 is speech of speaker A, sound data unit U2 is speech of speaker B, and sound data unit U5 is speech of speaker C.

In block BL1, the speech segment (the duration of the total speech segments) of speaker A is 1.5 (=0.5×3) seconds. Speaker A is therefore a speaker whose amount of speech is the largest in block BL1. The sound recorder application program 202 accordingly determines speaker A as a speaker (main speaker) of block BL1 (sound data units U1 to U5). The sound recorder application program 202 displays block BL1 in color allocated to speaker A (for example, red).

The similar processing is executed in all the remaining blocks. For example, in block BL2, the sound recorder application program 202 determines speaker C as a main speaker of block BL2. The sound recorder application program 202 displays block BL2 in color allocated to speaker C (for example, green).

Thus, in the embodiment, a speaker whose amount of speech is the largest in a certain block is a main speaker of the block. This block is displayed in a form where the determined main speaker can be identified. That is, the main speaker of the block is visually distinguishable. Individual short speech can therefore be presented to the user as speech having a length equivalent to one block.

However, only with the processing of FIG. 8, there is a possibility that the speech of a speaker who rarely speaks (for example, a speaker whose amount of speech is the smallest in the entire sequence of audio data) is buried in speeches of other speakers and that the speech of the speaker who rarely speaks cannot be presented to the user at all.

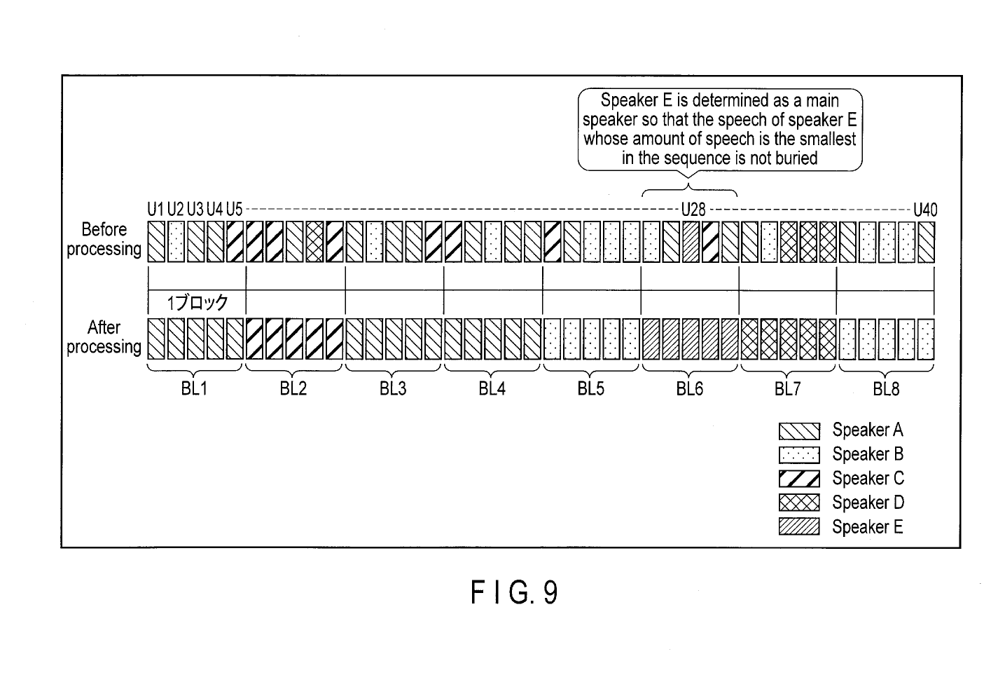

The sound recorder application program 202 therefore executes the processing shown in FIG. 9.

The upper section of FIG. 9 illustrates a result of speaker identification processing. It is assumed that sound data unit U28 is identified as speech of speaker E.

Sound data unit U28 is included in block BL6. Speaker A is determined as a main speaker of block BL6, if only the above-mentioned condition is used where a speaker whose amount of speech is the largest in block BL6 is a main speaker of this block. As a result, sound data unit U28 of speaker E is not visualized.

In a meeting, etc., it is necessary to pay attention also to a content of speech of a speaker whose amount of speech is the smallest in the entire meeting. The sound recorder application program 202 therefore takes into account the amount of speech of speaker E of the entire sequence of audio data. If speaker E is a speaker whose amount of speech is the smallest in the entire sequence of audio data, the sound recorder application program 202 determines speaker E as a main speaker of block BL6 as shown in the lower section of FIG. 9, although a speaker whose amount of speech in block BL6 is the largest is speaker A.

The sound recorder application program 202 then displays block BL6 in color allocated to speaker E (for example, gray). It is thereby possible to prevent the rare speech of speaker E who rarely speaks from being embedded in speeches of other speakers.

Regarding determination of a main speaker of block BL6, the sound recorder application program 202 may determine speaker E as a main speaker of block BL6 on the condition that speaker E is a speaker whose amount of speech in the entire sequence of audio data is smaller than that of speaker A.

Also, when the total recording time of a recording is approximately 8 minutes or less, each duration of 9,600 blocks is approximately 0.5 seconds. Therefore, regarding a recording whose total recording time is approximately 8 minutes or less, the sound recorder application program 202 may perform processing of drawing a speech segment on the time bar 701 in a sound data unit of 0.5 seconds. In addition, regarding a recording whose total recording time is approximately 8 minutes or less, the sequence of its audio data may be divided into the smaller number of blocks than 9,600.

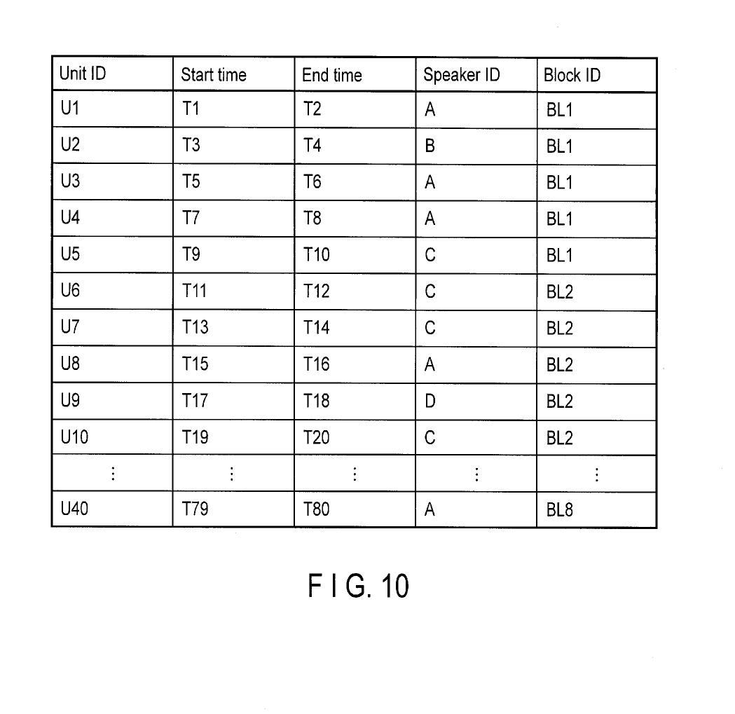

FIG. 10 illustrates an example of speaker identification result information that is obtained with speaker clustering executed by the sound recorder application program 202.

The speaker identification result information of FIG. 10 corresponds to the speaker identification result described in FIG. 9. The table of speaker identification result information includes a plurality of storage areas corresponding to the respective voice data units including speech. Each storage area includes a “unit ID” field, a “start time” field, an “end time” field, a “speaker ID” field and a “block ID” field. In the “unit ID” field, the ID of a corresponding voice data unit is stored. In the “start time” field, the start time of a corresponding voice data unit is stored. In the “end time” field, the end time of a corresponding voice data unit is stored. In the “speaker ID” field, the ID of a speaker of a corresponding voice data unit is stored. In the “block ID” field, the ID of a block that includes a corresponding voice data unit is stored.

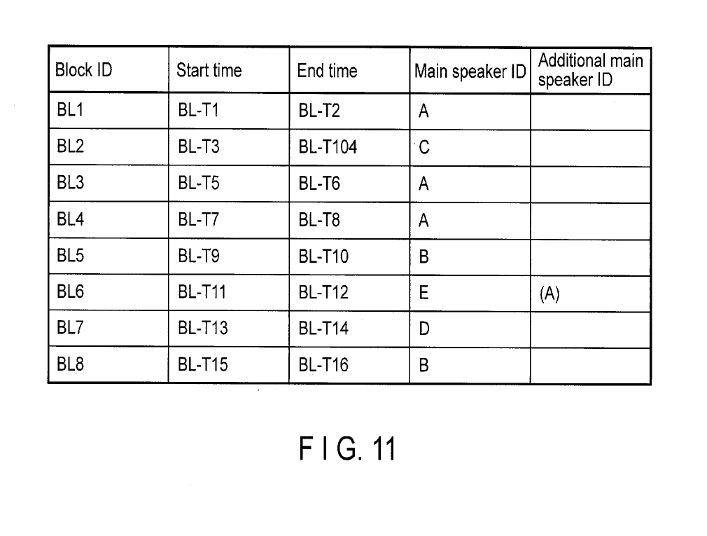

FIG. 11 illustrates main speaker management information generated by the sound recorder application program 202 based on speaker identification result information.

The table of main speaker management information includes a plurality of storage areas corresponding to the respective blocks. Each storage area includes a “block ID” field, a “start time” field, an “end time” field, a “main speaker ID” field and an “additional main speaker ID” field. In the “block ID” field, the ID of a corresponding block is stored. In the “start time” field, the start time of a corresponding block is stored. In the “end time” field, the end time of a corresponding block is stored. In the “main speaker ID” field, the ID of the main speaker of a corresponding block is stored. In the “additional main speaker ID” field, the ID of the additional main speaker of a corresponding block is stored.

In block BL1, the ID of speaker A is stored in the “main speaker ID” field. In block BL2, the ID of speaker C is stored in the “main speaker ID” field. In block BL6, the ID of speaker E is stored in the “main speaker ID” field. Also, in block BL6, the “additional main speaker ID” may store the ID of speaker A whose amount of speech is the largest in block BL6.

The speaker identification result information of FIG. 10 and the main speaker management information of FIG. 11 may be retained in the index data 402A.

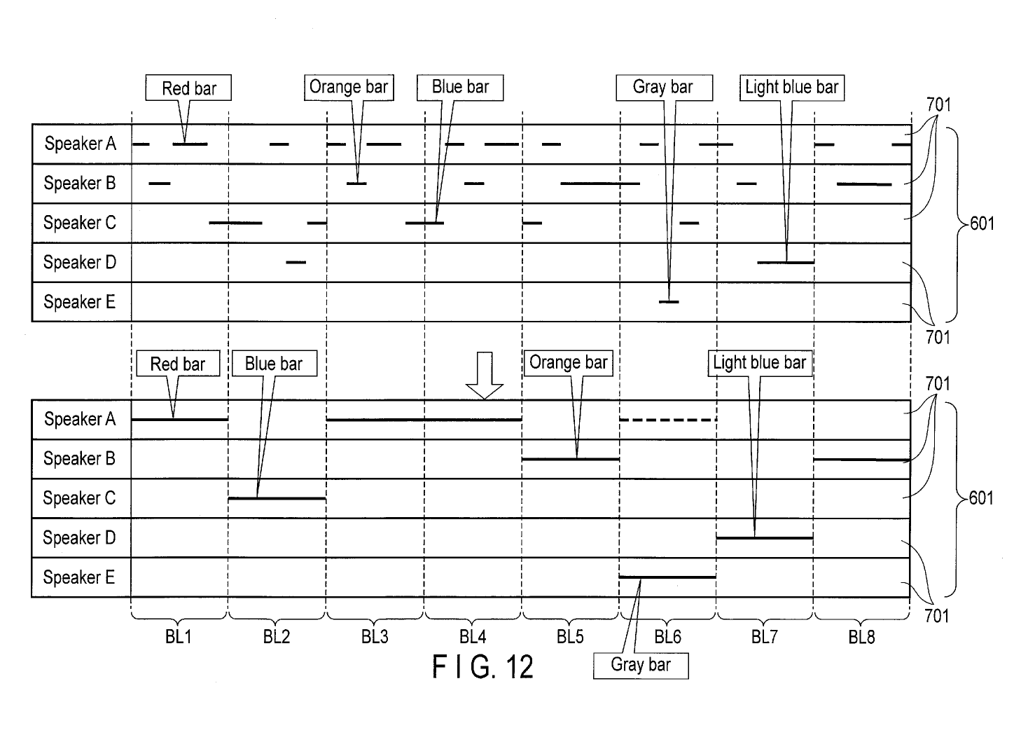

FIG. 12 illustrates a display content of a speaker identification result view area 601.

The upper section of FIG. 12 is a display example of the speaker identification result view area 601 based on the speaker identification result information of FIG. 10. The lower section of FIG. 12 is a display example of the speaker identification result view area 601 based on the main speaker management information of FIG. 11. As understood from the lower section of FIG. 12, each time bar (display area) 701 includes eight blocks, i.e., blocks BL1 to BL8, and displays a speech segment bar in a block unit. That is, the minimum unit of a speech segment bar is one block.

For example, in the time bar (display area) 701 of speaker A, blocks BL1, BL3 and BL4 where speaker A is determined as a main speaker are displayed in red corresponding to speaker A. In the time bar (display area) 701 of speaker B, blocks BL5 and BL8 where speaker B is determined as a main speaker are displayed in orange corresponding to speaker B. In the time bar (display area) 701 of speaker C, block BL2 where speaker C is determined as a main speaker is displayed in blue corresponding to speaker C. In the time bar (display area) 701 of speaker D, block BL7 where speaker D is determined as a main speaker is displayed in light blue corresponding to speaker D. In the time bar (display area) 701 of speaker E, block BL6 where speaker E is determined as a main speaker is displayed in gray corresponding to speaker E. Speaker E is a speaker whose amount of speech is the smallest in the entire sequence of this recording.

When a speaker whose amount of speech is the largest in block BL6 is speaker A, speaker A may be determined as an additional main speaker of block BL6. In this case, block BL6 is also displayed in red in the time bar (display area) 701 of speaker A. Thus, block BL6 is displayed in a form where both speakers E and A can be identified as main speakers of block BL6. That is, the main speaker of block BL6 and the additional main speaker of block BL6 are visually distinguishable.

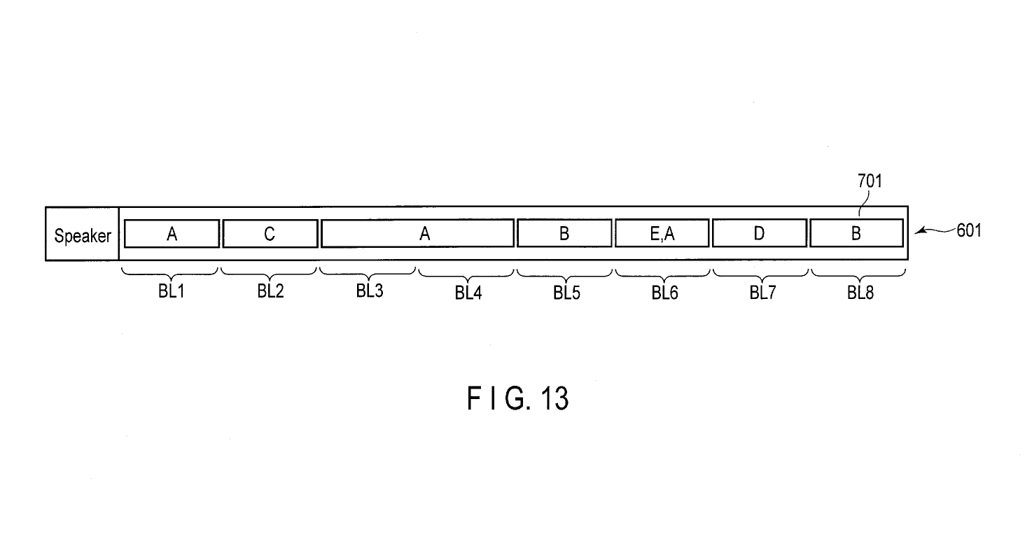

FIG. 13 is another display example of the speaker identification result view area 601 based on the main speaker management information of FIG. 11.

In the display example of FIG. 13, the single time bar (single display area) 701 common to speakers A to E is displayed. The time bar 701 includes eight blocks, i.e., blocks BL1 to BL8, and displays a speech segment bar in a block unit.

In the time bar 701, blocks BL1, BL3 and BL4 where speaker A is determined as a main speaker are displayed in a form where speaker A can be visually distinguished. For example, alphabet “A” may be displayed on blocks BL1, BL3 and BL4. Since block BL3 is followed by block BL4, only one alphabet “A” common to blocks BL3 and BL4 may be displayed in an area that includes both blocks BL3 and BL4.

Blocks BL5 and BL8 where speaker B is determined as a main speaker are displayed in a form where speaker B can be visually distinguished. For example, alphabet “B” may be displayed on blocks BL5 and BL8. In block BL6, alphabet “E” corresponding to speaker E and alphabet “A” corresponding to speaker A may be both displayed.

Also, in the single time bar 701 of FIG. 13, blocks may be displayed in different colors for different speakers. In this case, block BL6 is displayed in color corresponding to speaker E and a red mark, etc., corresponding to speaker A may further be added near block BL6.

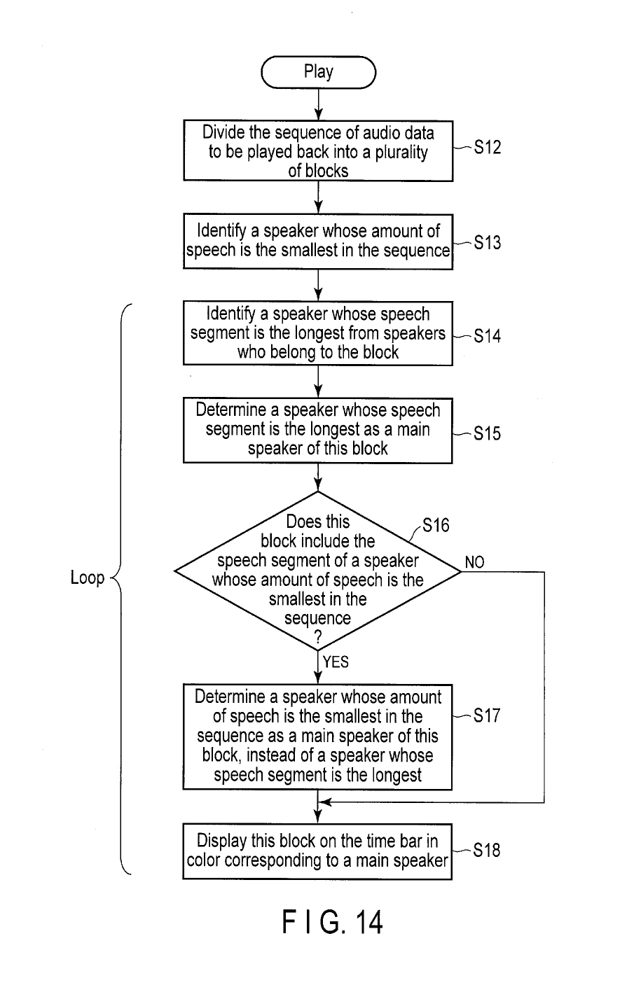

The flowchart of FIG. 14 illustrates the steps of processing for displaying the speaker identification result view area 601 corresponding to audio data to be played back.

The CPU 101 of the tablet computer 1 divides the sequence of audio data to be played back into a plurality of blocks (for example, 960 blocks) (step S12). The CPU 101 then identifies a speaker whose amount of speech is the smallest in the entire sequence of audio data, based on the index data 402A.

Next, the CPU 101 performs the following processing for each block.

The CPU 101 identifies a speaker whose speech segment (total speech segment) is the longest in a target block, i.e., a speaker whose amount of speech is the largest in a target block (step S14). The CPU 101 then determines (tentatively determines) a speaker whose speech segment (total speech segment) is the longest in a target block as a main speaker of the target block (step S15).

Subsequently, the CPU 101 determines whether a speaker whose amount of speech is the smallest in the entire sequence of audio data is included in other speakers (speakers who are not selected as main speakers) in the target block, i.e., whether the speech segment of a speaker whose amount of speech is the smallest in the entire sequence of audio data exists in the target block (step S16).

If a speaker whose amount of speech is the smallest in the entire sequence of audio data is not included in the speakers who are not selected as main speakers, i.e., if the speech segment of a speaker whose amount of speech is the smallest in the entire sequence of audio data does not exist in the target block (step S16, NO), the CPU 101 determines a speaker whose speech segment (total speech segment) is the longest in a target block as a main speaker of the target block. The CPU 101 then displays the target block on the time bar in color corresponding to a main speaker (a speaker whose total speech segment is the longest in the target block) (step S18).

In contrast, if a speaker whose amount of speech is the smallest in the entire sequence of audio data is included in the speakers who are not selected as main speakers, i.e., if the speech segment of a speaker whose amount of speech is the smallest in the entire sequence of audio data exists in the target block (step S16, YES), the CPU 101 determines a speaker whose amount of speech is the smallest in the entire sequence of audio data as a main speaker of the target block instead of a speaker whose total speech segment is the longest in the target block (step S17). The CPU 101 then displays the target block on the time bar in color corresponding to a main speaker (a speaker whose amount of speech is the smallest in the entire sequence of audio data) (step S18).

While a method has been described where a speaker whose amount of speech is the smallest in the sequence (entire sequence) of audio data is determined as a main speaker in priority, a method may also be adopted where a speaker whose amount of speech in the sequence (entire sequence) of audio data is smaller than the standard value (first amount) is determined as a main speaker in priority.

Also, while an example has been mainly described where only a speaker whose amount of speech is the smallest in a sequence of audio data is determined as a main speaker in priority, a speaker whose amount of speech is the second smallest in a sequence of audio data may also be determined as a main speaker in priority.

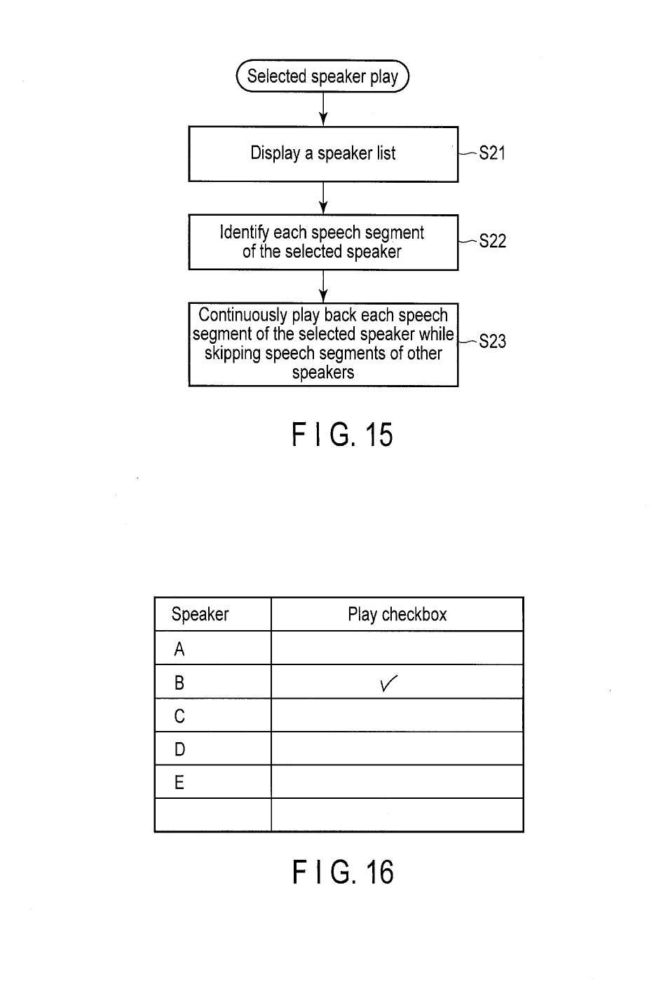

The flowchart of FIG. 15 illustrates the steps of selected speaker playback processing.

The user can, as necessary, select a selected speaker playback function by operating the control panel 604 on the play view 210-3 of FIG. 6. When the selected speaker playback function is selected, the CPU 101 displays on the play view 210-3 a speaker list shown in FIG. 16 (step S21).

As shown in FIG. 16, a checkbox list is added to the speaker list. In the checkbox list, all the speakers may be checked in advance. The user can select one or more particular speakers by unchecking speakers other than a desired speaker.

If a certain speaker (for example, speaker B) is selected, the CPU 101 identifies each speech segment of the selected speaker (for example, speaker B) based on the index data 402A (step S22). The CPU 101 then continuously plays back speech segments of the selected speaker (for example, speaker B) while skipping speech segments of other speakers (step S23). The speech segment played back in step S23 is, for example, an actual speech segment detected, not a speech segment adjusted in length.

If two speakers are selected by the user, the CPU 101 identifies the respective speech segments corresponding to the two speakers and continuously plays back these identified speech segments while skipping speech segments of other speakers.

As described above, in the embodiment, if the first speech segment of the first speaker and the second speech segment of the second speaker are included in a certain block, the first speech segment is longer than the second speech segment, and the second speaker is not a speaker whose amount of speech in a sequence of audio data is smaller than that of the first speaker or the first amount, the first speaker is determined as the main speaker of the certain block block.

In contrast, if the first speech segment of the first speaker and the second speech segment of the second speaker are included in a certain block, the first speech segment is longer than the second speech segment, and the second speaker is a speaker whose amount of speech in the sequence of audio data is smaller than that of the first speaker or the first amount, the second speaker is determined as the main speaker of the certain block block.

It is therefore possible to put together some short speeches next to each other as speeches of a certain main speaker while preventing the rare speech of a speaker whose amount of a sequence of audio data is small from being embedded in speeches of other speakers. Accordingly, it is possible to prevent an extremely short bar that is hard to view from being drawn on a display area and to present to the user an outline of recorded data.

In the embodiment, while an example has been mainly described where only a speaker whose amount of speech is the smallest in a sequence is determined as a main speaker in priority, a speaker whose amount of speech is the second smallest in a sequence may also be determined as a main speaker in priority.

Each of the various functions described in the embodiment may be realized by circuitry (processing circuitry). The examples of processing circuitry include a programmed processor such as a central processing unit (CPU). This processor executes each of the described functions by executing computer programs (instructions) stored in its memory. This processer may be a microprocessor including an electronic circuit. The examples of processing circuitry include a digital signal processor (DSP), an application specific integrated circuit (ASIC), a microcomputer, a controller, and other electronic circuit components. Each of other components other than the CPU described in the embodiment may also be realized by processing circuitry.

Also, since each processing in the present embodiment can be realized by a computer program, the same effect as the present embodiment can be easily realized only by installing and executing the computer program to a normal computer through a computer-readable storage medium that stores the computer program.

Further, each function of the embodiment is effective for visualizing the recording of a meeting. However, each function of the embodiment is applicable not only to the recording of a meeting but also to various other types of recordings and various audio data including speech such as a news program and a talk show.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
circuitry configured to execute a first process for displaying a first block comprising speech segments, wherein a main speaker of the first block is visually distinguishable, and the first block is one of a plurality of blocks included in a sequence of audio data, wherein
when the first block comprises a first speech segment of a first speaker and a second speech segment of a second speaker, the first speech segment is longer than the second speech segment, and the second speaker is not a speaker whose amount of speech in the sequence of the audio data is smaller than that of the first speaker or a first amount, the first speaker is determined as a main speaker of the first block, and
when the first block comprises the first speech segment and the second speech segment, the first speech segment is longer than the second speech segment, and the second speaker is a speaker whose amount of speech in the sequence of the audio data is smaller than that of the first speaker or the first amount, the second speaker is determined as the main speaker of the first block.

2. The electronic device of claim 1, wherein
when the first block comprises the first speech segment and the second speech segment, the first speech segment is longer than the second speech segment, and the second speaker is a speaker whose amount of speech in the sequence of the audio data is smaller than that of the first speaker or the first amount, the first speaker is determined as an additional main speaker of the first block, and
the first block is displayed in a form where both the main speakers of the first block and the additional main speaker of the first block are visually distinguishable.

3. The electronic device of claim 1, wherein
the first process comprises displaying on a screen a plurality of display areas corresponding to a plurality of speakers in the sequence of the audio data, each of the plurality of display areas comprising the plurality of blocks,
each block where the first speaker is determined as the main speaker is displayed in a first form, in a first display area of the plurality of display areas corresponding to the first speaker, and
each block where the second speaker is determined as the main speaker is displayed in a second form, in a second display area of the plurality of display areas corresponding to the second speaker.

4. The electronic device of claim 1, wherein
the first process comprises displaying on a screen a single display area common to a plurality of speakers in the sequence of the audio data, the single display area comprising the plurality of blocks, and
in the single display area, each block where the first speaker is determined as the main speaker is displayed in a first form where the first speaker is identifiable and each block where the second speaker is determined as the main speaker is displayed in a second form where the second speaker is identifiable.

5. The electronic device of claim 1, wherein
the circuitry is configured to further execute a process for continuously playing back speech segments corresponding to a speaker selected from a plurality of speakers of the sequence of the audio data while skipping speech segments of other speakers.

6. A method executed by an electronic device, the method comprising:
executing a first process for displaying a first block comprising speech segments, wherein a main speaker of the first block is visually distinguishable, and the first block is one of a plurality of blocks included in a sequence of audio data, wherein
when the first block comprises a first speech segment of a first speaker and a second speech segment of a second speaker, the first speech segment is longer than the second speech segment, and the second speaker is not a speaker whose amount of speech in the sequence of the audio data is smaller than that of the first speaker or a first amount, the first speaker is determined as a main speaker of the first block, and
when the first block comprises the first speech segment and the second speech segment, and the second speaker is a speaker whose amount of speech in the sequence of the audio data is smaller than that of the first speaker or the first amount, the second speaker is determined as the main speaker of the first block.

7. The method of claim 6, wherein
when the first block comprises the first speech segment and the second speech segment, the first speech segment is longer than the second speech segment, and the second speaker is a speaker whose amount of speech in the sequence of the audio data is smaller than that of the first speaker or the first amount, the first speaker is determined as an additional main speaker of the first block, and
the first block is displayed in a form where both the main speakers of the first block and the additional main speaker of the first block are visually distinguishable.

8. The method of claim 6, wherein
the first process comprises displaying on a screen a plurality of display areas corresponding to a plurality of speakers in the sequence of the audio data, each of the plurality of display areas comprising the plurality of blocks,
each block where the first speaker is determined as the main speaker is displayed in a first form, in a first display area of the plurality of display areas corresponding to the first speaker, and
each block where the second speaker is determined as the main speaker is displayed in a second form, in a second display area of the plurality of display areas corresponding to the second speaker.

9. The method of claim 6, wherein
the first process comprises displaying on a screen a single display area common to a plurality of speakers in the sequence of the audio data, the single display area comprising the plurality of blocks, and
in the single display area, each block where the first speaker is determined as the main speaker is displayed in a first form where the first speaker is identifiable and each block where the second speaker is determined as the main speaker is displayed in a second form where the second speaker is identifiable.

10. The method of claim 6, further comprising continuously playing back speech segments corresponding to a speaker selected from a plurality of speakers of the sequence of the audio data while skipping speech segments of other speakers.

11. A computer-readable, non-transitory storage medium having stored thereon a computer program which is executable by a computer, the computer program controlling the computer to execute a function of:
executing a first process for displaying a first block comprising speech segments, wherein a main speaker of the first block is visually distinguishable, and the first block is one of a plurality of blocks included in a sequence of audio data, wherein
when the first block comprises a first speech segment of a first speaker and a second speech segment of a second speaker, the first speech segment is longer than the second speech segment, and the second speaker is not a speaker whose amount of speech in the sequence of the audio data is smaller than that of the first speaker or a first amount, the first speaker is determined as the main speaker of the first block, and
when the first block comprises the first speech segment and the second speech segment, the first speech segment is longer than the second speech segment, and the second speaker is a speaker whose amount of speech in the sequence of the audio data is smaller than that of the first speaker or the first amount, the second speaker is determined as the main speaker of the first block.

12. The storage medium of claim 11, wherein
when the first block comprises the first speech segment and the second speech segment, the first speech segment is longer than the second speech segment, and the second speaker is a speaker whose amount of speech in the sequence of the audio data is smaller than that of the first speaker or the first amount, the first speaker is determined as an additional main speaker of the first block, and
the first block is displayed in a form where both the main speakers of the first block and the additional main speaker of the first block are visually distinguishable.

13. The storage medium of claim 11, wherein
the first process comprises displaying on a screen a plurality of display areas corresponding to a plurality of speakers in the sequence of the audio data, each of the plurality of display areas comprising the plurality of blocks,
each block where the first speaker is determined as the main speaker is displayed in a first form, in a first display area of the plurality of display areas corresponding to the first speaker, and
each block where the second speaker is determined as the main speaker is displayed in a second form, in a second display area of the plurality of display areas corresponding to the second speaker.

14. The storage medium of claim 11, wherein
the first process comprises displaying on a screen a single display area common to a plurality of speakers in the sequence of the audio data, the single display area comprising the plurality of blocks, and
in the single display area, each block where the first speaker is determined as the main speaker is displayed in a first form where the first speaker is identifiable and each block where the second speaker is determined as the main speaker is displayed in a second form where the second speaker is identifiable.

15. The storage medium of claim 11, wherein
the computer program further controls the computer to execute a function of continuously playing back speech segments corresponding to a speaker selected from a plurality of speakers of the sequence of the audio data while skipping speech segments of other speakers.
